(19) United States
(12) Patent Application Publication
(10) Pub. No.: US 2018/0144187 A1
(43) Pub. Date: May 24, 2018

(54) Method and Apparatus for Providing Business Object Information

(71) Applicant: Alibaba Group Holding Limited, Hangzhou (CN)

(72) Inventor: Yazhuo XU, Hangzhou (CN)

(21) Appl. No.: 15/872,858

(22) Filed: Jan. 16, 2018

Related U.S. Application Data
(63) Continuation of application No. PCT/CN2016/089306, filed on Jul. 8, 2016.

(30) Foreign Application Priority Data
Jul. 17, 2015 (CN) 201510425231.1

(51) Int. Cl. G06K 9/00; G06F 17/30; G06K 9/62; G06Q 30/06; G06T 7/73

(52) U.S. Cl. CPC G06K 9/00369; G06F 17/30867; G06F 3/0482; G06Q 30/0601; G06T 7/75; G06K 9/6217

(57) ABSTRACT

A method and an apparatus for providing business object information are disclosed. The method includes pre-establishing a first database by a server, the first database being used for storing body property data of first users; determining a first business object information set for a client of a target first user; determining target body property data of the target first user based on the first database; determining whether an inventory of a target model that matches the target body property data exists in business objects in the first business object information set; and providing business object information to the client of the target first user based on a determination result. Through the embodiments of the present disclosure, the waste of network resources caused by transmission of invalid information can be reduced, and the effectiveness of information displayed in a list interface of a client is improved.

### CROSS REFERENCE TO RELATED PATENT APPLICATIONS

This application claims priority to and is a continuation of PCT Patent Application No. PCT/CN2016/089306 filed on 8 Jul. 2016, and is related to and claims priority to Chinese Patent Application No. 201510425231.1, filed on 17 Jul. 2015, entitled “Method and Apparatus for Providing Business Object Information,” which are hereby incorporated by reference in their entirety.

### TECHNICAL FIELD

The present disclosure relates to the technological field of information processing of business objects, and particularly to methods and apparatuses for providing business object information.

### BACKGROUND

An e-commerce sales platform provides business objects to buying users in a number of different manners, which include browsing according to categories triggered by a user, conducting searches according to search criteria, or providing recommendations according to user preferences triggered by a server, etc. A buying user can select one that is of interest from a page that includes a list of link information of multiple business objects for performing operations such as making a purchase, saving in a collection, etc. Some business objects possess a model attribute. When selecting this type of business object, a user generally also needs to select a model that is suitable therefor, in addition to a style of the business object, for example. Examples include bra, shoes, jeans, cosmetics, etc.

In existing technologies, links of business objects are usually displayed in a page of a business object list. Furthermore, for the sake of providing convenience to users for viewing, a link is generally formed by two parts. One part is an image (e.g., a thumbnail image of a descriptive image of an associated business object). Another part of information is textual information such as a title, sales volume, etc. A user can select a style that is of interest thereto using these link images or link texts as a reference basis. Specific models are displayed in a detailed page of a business object that is redirected into after a buying user selects a certain link in a list page, from which the user makes a selection. After selecting a model that is needed, the buying user can perform further operations such as making a purchase, adding into a “shopping cart”, etc.

However, the following situations usually occur in the existing technologies. After selecting a certain business object in a list page and attempting to select a model in a detailed page thereof, a buying user discovers that no suitable model exists, or a suitable model is out of stock, and thus cannot make a purchase. In this case, the buying user can only return to the list page to select other business object. This apparently wastes the time of the buying user, results in poor efficiency and affects the experience of the user. From the perspective of a system, switching between pages repeatedly by a user would occupy resources of the system, and increase an access pressure on a server.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides methods and apparatuses for providing information of a business object, which can reduce the waster of network resources caused by a transmission of invalid information, and improve the effectiveness of information displayed in a list interface of a client.

The present disclosure provides the following technical solutions.

A method for providing information of a business object, includes pre-establishing a first database by a server, the first database being used for storing body property data of first users; determining a first business object information set for a client of a target first user; determining target body property data of the target first user based on the first database; determining whether an inventory of a target model that matches the target body property data exists in business objects in the first business object information set; and providing business object information to the client of the target first user based on a determination result.

A method for providing information of a business object, includes receiving business object information from a server by a first user client, the business object information being determined by the server using a way including pre-establishing a first database by the server, the first database being used for storing body property data of first users, determining a first business object information set for a client of a target first user; determining target body property data of the target first user based on the first database, determining whether an inventory of a target model that matches the target body property data exists in business objects in the first business object information set, and providing business object information to the first user client based on a determination result; and generating display content in a list display page based on the received business object information.

An apparatus for providing information of a business object, includes a first data database creation unit used for pre-establishing a first database by a server, the first database being used for storing body property data of first users; a first set determination unit used for determining a first business object information set for a client of a target first user; a target body property data determination unit used for determining target body property data of the target first user based on the first database; an inventory determination unit used for determining whether an inventory of a target model that matches the target body property data exists in business objects in the first business object information set; and a business object information provision unit used for providing business object information to the client of the target first user based on a determination result.

An apparatus for providing information of a business object, includes an information receiving unit used for receiving business object information from a server by a first user client, the business object information being determined by the server using a way including pre-establishing a first database by the server, the first database being used for storing body property data of first users, determining a first business object information set for a client of a target first user; determining target body property data of the target first user based on the first database, determining whether an inventory of a target model that matches the target body property data exists in business objects in the first business object information set, and providing business object information to the first user client based on a determination result; and a display content generation unit used for generating display content in a list display page based on the received business object information.

According to the embodiments provided by the present disclosure, the present disclosure discloses the following technical advantages.

Using the embodiments of the present disclosure, body property data of first users can be stored in advance. In this way, when a business object information set is provided to a first user, body property data of the user can first be matched with models of business objects, and a determination is made as to whether a matched model of a business object is in stock. Business object information can thereby be provided based on a determination result. For example, only business object information of matched models that are in stock is provided to a client of the first user. This can reduce the waste of network resources caused by transmission of invalid information. Furthermore, the effectiveness of information displayed in a list interface of a client is improved. This is especially true in a situation where browsing is performed in a small-screen device such as a mobile device. Since a number of business objects that are displayed in each screen are limited, the improvement in the effectiveness of information is more meaningful.

Apparently, any product implementing the present disclosure does not need to achieve all of the above advantages at the same time.

### BRIEF DESCRIPTION OF THE DRAWINGS

In order to describe the technical solutions of the embodiments of the present disclosure in a better manner, accompanying drawings that are needed by the embodiments are briefly described herein. Apparently, the accompanying drawings described herein merely represent some embodiments of the present disclosure. One of ordinary skill in the art can also obtain other drawings using these accompanying drawings without making any creative effort.

FIG. 1 is a flowchart of a method provided by the embodiments of the present disclosure.

FIG. 2-1 is a schematic diagram of a list page of a client provided by the embodiments of the present disclosure.

FIG. 2-2 is a schematic diagram of another list page of a client provided by the embodiments of the present disclosure.

FIG. 3 is a flowchart of another method provided by the embodiments of the present disclosure.

FIG. 4 is a schematic diagram of an apparatus provided by the embodiments of the present disclosure.

FIG. 5 is a schematic diagram of another apparatus provided by the embodiments of the present disclosure.

### DETAILED DESCRIPTION

The technical solutions of the embodiments of the present disclosure are described in a clear and comprehensive manner in conjunction with the accompanying drawings of the embodiments of the present disclosure. Apparently, the described embodiments merely represent some and not all of the embodiments. Based on the embodiments in the present disclosure, all other embodiments that are obtained by one of ordinary skill in the art shall fall in the scope of protection of the present disclosure.

During implementation of the embodiments of the present disclosure, the inventors of the present disclosure have noted that if a certain business object does not have a model suitable for a current first user (who can be a buying user in a sales platform, and a selling user or merchant in the sales platform can be called a second user correspondingly) or the suitable model is out of stock, this is actually invalid information if a business object list provides this business object to the buying user. Regardless of whether from the perspective of network transmission or from the perspective of the occupancy of display areas when being displayed in a user interface of a client, this type of information is a waste. Based on this consideration, body property data of first users, which includes, for example, heights, waistlines, foot lengths, skin types of the first users, etc., can be stored in advance in the embodiments of the present disclosure. In this way, when business object information is provided to a first user, business object information for models that are suitable for the first user and are in stock can first be selected based on body property data of the first user, and this type of information is then provided to the first user. As such, the effectiveness of business object information that is provided to the first user is improved, and the waste of resources caused by invalid information is reduced.

The embodiments of the present disclosure are first described herein from the perspective of a server.

### First Embodiment

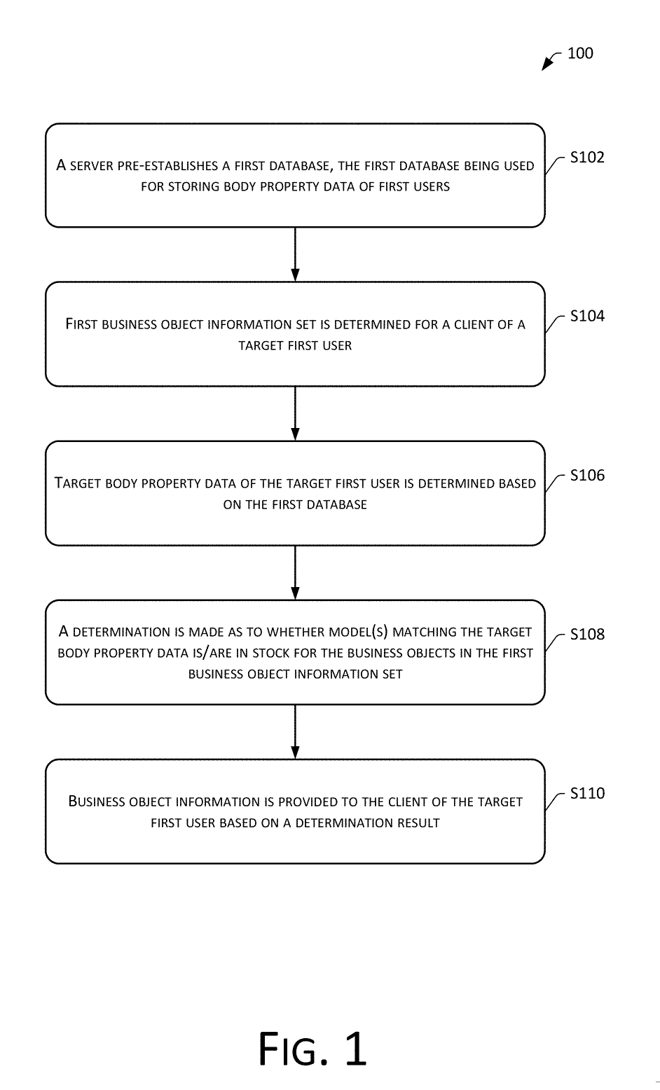

Referring to FIG. 1, this first embodiment provides a method 100 for providing information of a business object. The method 100 may include the following operations.

At S102, a server pre-establishes a first database, the first database being used for storing body property data of first users. The first database is mainly used for storing the body property data of the first users, which, in implementations, may be like the one shown in Table 1, for example.

TABLE 1

| User | Height | Waist | Upper chest | Lower chest | Foot length | |
|---|---|---|---|---|---|---|
| ID | (cm) | (cm) | measurement (cm) | measurement (cm) | (cm) | Skin type |
| User A | 160 | 57 | 85 | 75 | 24 | Oily |
| User B | 165 | 60 | 88 | 77 | 26 | Dry |
| . . . | . . . | . . . | . . . | . . . | . . . | . . . |

The above first database can be obtained in a number of different manners.

For example, in one approach, this can be obtained from information such as user information inputted by the first users. Apparently, data that can be obtained is different according to differences in completeness of the information inputted by the users.

Alternatively, in another approach, a user usually inputs body property data thereof when inputting comment information for a business object purchased thereby (for example, inputting comment information for a certain pairs of jeans), a system can provide an option of operation for inputting information such as waistline, etc., to a first user. In this way, if needing to share details of his/her buying experience to other first users, a certain first user can input data about his/her waistline through this option of operation. As such, this information has a higher reference value for the other first users. In this situation, body property data related to the first user may exist in comment information database, from which this type of data can be extracted.

In another implementation, since some transaction platforms also provide a function to communicate with customer service personnel of second users to a first user, the first user can communicate with customer service personnel of a second user regarding questions such as model selection before selecting a specific business object. During this process, the first user may describe body property data thereof. For example, when purchasing a certain pair of jeans, a first user may describe his/her waist size, and ask customer service which model he/she needs to buy, etc. A server can store this type of conversation data. Therefore, body property data of first users can be extracted from this type of conversation data that is stored in the server.

Apparently, in these foregoing implementations, the body property data of the first users that is collected may be relatively scattered. Therefore, a number of different types of data sources can be combined to extract multiple pieces of body property data. For example, data about a waist size of a certain first user is extracted from historical comment information, and data about skin type of this first user is extracted from historical conversation data of customer service personnel of a second user, etc.

Additionally, an option of operation for submitting body property data needed by the embodiments of the present disclosure may further be provided to the first users. For example, the option of operation may be provided in an interface such as “configuration”. As such, a first user can input and submit various pieces of body property data through the option of operation.

At S104, first business object information set is determined for a client of a target first user.

The first business object information set determined by the server can be configured according to specific business scenarios. For example, in a scenario when a user performs browsing according to categories, a set formed by business object information that possesses category tags specified by the user can be provided. An example includes providing a set of business objects of long dresses, etc. Alternatively, when a user inputs a keyword for conducting a search, a set formed by business object information corresponding to the keyword can be provided. Alternatively, during a process of actively providing recommendation, the server obtains preference information of a user from an analysis based on historical purchases and browsing history, etc., of the user, and provides to the user a set that is formed by business object information of interest to the user. How to obtain specific business object information sets under various specific scenarios can be referenced to the description of existing technologies, and is not described in detail herein.

At S106, target body property data of the target first user is determined based on the first database.

After determining the first business object set and before returning specific information to the client of the first user using data in the first business object information set, target body property data of the target first user can also be determined first based on the first database at S102. It should be noted that the database may store a plurality of pieces of body property data (i.e., body property data in multiple dimensions, which includes a height, a waist size, an upper chest measurement, a lower chest measurement, etc.) for the first user as shown in Table 1. However, for a specific business object, body property data in one or a number of dimensions may need to be referenced when a model is selected. Furthermore, dimensions needed to be referenced may be different for different categories of business objects. For example, a dimension needed to be referenced may be a waist size for a pair of jeans, and dimensions needed to be referenced may be an upper chest measurement and a lower chest measurement, etc. Therefore, in implementations, respective correspondence relationships between categories and reference dimensions of body property data may also be established in advance. An example is shown in Table 2 as follows:

TABLE 2

| Category | Reference dimension(s) of body property data |
|---|---|
| Pant | Waist size |
| Shoes | Foot length |
| Bra | Upper chest measurement and lower chest measurement |
| Cosmetics | Skin type |
| . . . | . . . |

As such, when determining the target body property data of the target first user, the target body property data of the target first user in corresponding reference dimension(s) can be extracted from the first database based on categories to which specific business objects in the first business object information set belong and the pre-established correspondence relationships between the categories and the reference dimensions of the body property data. For example, business objects in a certain first business object set belong to a “pant” category. In this case, a corresponding reference dimension that can be determined by querying the above Table 2 is “waist size”. As such, specific body property data of the first user in a dimension associated with the waist size can be obtained from Table 1, i.e., a specific waist circumference.

Business objects in the first business object set may belong to a same category, or may belong to different categories. Information of a category to which a business object belongs can be determined in a number of different ways. For example, in a most straightforward approach, each business object generally carries attribute information about a category to which it belongs. This information is stored in a business object information database, or embedded in description information of the business object by means of a tag. Therefore, the category to which the business object belongs can be directly determined based on this type of information. Alternatively, in another implementation, since the first business object information set may be obtained according to a browsing request submitted by the first user and a specific category may be selected before sending the browsing request (i.e., what is sent by the client of the first user is a browsing request directed to browsing a specified category), business objects in the first business object information set usually all belong to this specified category. Therefore, the category to which the business objects in the set belong can be directly determined based on the specified category included in the browsing request. Furthermore, the first business object information may also be determined based on a search request of the first user. A search request sent by a client of a first user usually also includes a search keyword, and this search keyword may generally have an association with a category. Furthermore, business objects in a first business object information set that are obtained for this search request are all related to this search keyword. Therefore, category information corresponding to the search keyword included in the search request can further be determined first, and this category information is determined to be a target category to which the business objects in the set belong. For example, a certain search keyword is “jeans”, and a corresponding category may be determined to be “pants”. Therefore, a category to which business objects in a business object set are determined to be “pants”. In short, using the latter two methods, a category to which business objects can be determined without the need of querying tags of the business objects one by one, thus helping to improve the efficiency of processing.

At S108, a determination is made as to whether model(s) matching the target body property data is/are in stock for the business objects in the first business object information set.

After the first business object information set and the target body property data of the target first user are determined, a determination can be made as to whether target models matching the target body property data are in stock for the business objects in the set. For example, for a first user searching for a pair of jeans, business objects in a first business object set may satisfy this criterion of belonging to a category of jeans. However, whether models thereof satisfy the current need of the first user is not sure. Therefore, in the embodiments of the present disclosure, a determination may first be made.

In implementations, this operation can be divided into two sub-operations for implementation. First, target models of the business object in the set that match the body property data of the current first user are determined. A determination of whether the target models of the business objects are in stock is then made by such method as accessing an inventory center server, for example. For instance, a certain first user needs to search for a pair of jeans. A waist size of the first user is 54 cm. For a certain specific business object, a model matching with this waist data is “size 26”. A query may then be made to an inventory center server about whether an inventory of “size 26” of the business object exists. If affirmative, this business object satisfies the need of the current first user with respect to model, for example.

In order to facilitate understanding, distinctions and relations between models of body property data of users and business objects are described first. Body property data of a user is generally data obtained for the user through measurements, for example. A tool for measuring a length in a real-world application is generally a metric scale. Therefore, body property data obtained from measurements generally uses “cm” as a unit. For example, in Table 1 described above, body property data such as a height, a waist size, a chest size, a foot length, etc., uses “cm” as a unit. Furthermore, specific body property data related to a skin type can generally be obtained using related tools, and this body property data generally includes “oily”, “dry”, “mixed”, etc.

A model of a business object is determined based on industry standard, for example. Representations of models of business objects of different categories are different. For example, a model of a bra is formed by two parts: a bottom circumference size and a cup size. The bottom circumference size is generally represented by a length of chest size, and the cup size is generally represented by English capital letter such as A, B, C. Examples are 70A, 75B, etc. A size of shoe type is represented by a size of shoes, such as 35-42, etc. A model of jeans has a number of different representations. For example, “L” represents large, “M” represents medium, “S” represents” small, “XL” represents extra large, and “XXL” represents extra extra large, etc. Alternatively, the model of the jeans can also be represented by a suitable height, such as 155 cm, 160 cm, etc. Alternatively, the model of the jeans may be represented by a waist size. In this case, a unit for the waist size is an inch, e.g., “26” represents that the waist size is “1.9 m” in length, “27” represents that the waist size is “2.0 m”, and “28” represents that the waist size is “2.1 m”, etc. A model of cosmetics is a moisturizing type, a refreshing type, etc.

As can be seen, the meanings represented by the models of the body property data of the users and the business objects are different. In the first database as shown in Table, body property data of a user generally uses cm as a unit. On the other hand, a model of a business object is generally not represented using cm, and is represented in other forms. However, these two have a certain relation. For example, a user having a waist size of 54 cm is usually suitable to wear pants of “size 26”, and a user of a dry skin type is relatively suitable to use a cosmetics of a moisturizing type.

Therefore, at S108, models of the business objects in the set that match with the body property data of the current first user can also be determined. When implemented, a number of different implementations can exist. For example, in an implementation, business objects of a same category usually have a standard or universal characteristic with respect to a model. For example, if different jeans have a same “size 26”, a first user having a waist size of about 54 cm is suitable thereto. Therefore, in this implementation, a second database can be established in advance. The second database is used for storing first correspondence relationships between models of business objects and body property data ranges, and each business object category corresponds to a different first correspondence relationship. In different first correspondence relationships, dimensions of body property data may be different. An example is shown in Table 3.

TABLE 3

| Business object | | Body property | Body property |
|---|---|---|---|
| category | Model | data dimension | data range |
| Pants | 26 | Waist size | 54 cm |
| | 27 | Waist size | 55 cm |
| | . . . | . . . | . . . |
| Cosmetics | Moisturizing type, | Skin type | Dry |
| | refreshing, amino acid | | |
| | Refreshing | Skin type | Oily |
| | . . . | . . . | . . . |
| . . . | . . . | . . . | . . . |

In this way, for a certain business object in the set, when the models matching the body property data of the current first user is determined, a target category to which the business object belongs can first be determined, e.g., the target category is pants. A target first correspondence relationship corresponding to the target category is then determined. For example, the target first correspondence relationship corresponding to the category of pants is shown in Table 3. A determination may then be made as to whether the target body property data of the current first user is located within a certain body property data range in the target first correspondence relationship. For example, if the waist size of the current first user is 54, a first row in Table 3 is matched therewith, i.e., a body property data range in the first row is a successfully matched target body property data range. A model corresponding to the target body property data range may then be determined as the matched target model, i.e., determining that the target model that matches with the waist size of the current first user is “size 26”.

The second database as shown in Table 3 can be pre-established based on information such as industry standard of various categories. Furthermore, in implementations, in order to avoid a structure of the database to be too complicated, first correspondence relationships corresponding to various categories can also be recorded in different second databases. Furthermore, how to determine respective categories to which business objects in a set belong can be referenced to the description of S106, and is not repeatedly described in detail herein.

The above is an implementation of creating a correspondence relationship for a same category, and has advantages such as having a high efficiency occupying less storage resources, and facilitating queries. However, the following situations may also exist in a real application. A situation in which sizes of specific business objects may not be very standardized in reality, though models in different industries possess standards thereof. For example, sizes of some business objects may be biased—too large or too small. In these situations, situations such as discrepancies may occur if models of business objects matching the body property data are simply determined according to categories.

Therefore, in another implementation, a third database may also be pre-established. The third database is used for storing second correspondence relationships between models of business objects and body property data ranges. Each business object corresponds to a second correspondence relationship thereof. For example, the third database may be like the one as shown in Table 4.

TABLE 4

| Business object | | Body property | Body property |
|---|---|---|---|
| id | Model | data dimension | data range |
| Id1 | 26 | Waist size | 39 cm |
| | 27 | Waist size | 40 cm |
| | . . . | . . . | . . . |
| Id2 | 26 | Waist size | 38 cm |
| | 27 | Waist size | 39 cm |
| | . . . | . . . | . . . |
| . . . | . . . | . . . | . . . |

As can be seen from Table 4 above, although id1 and id2 both belong to a category of pants, body property data ranges corresponding to a same model are not the same. In other words, of pants of “size 26” having id1 are suitable for a user having a waist size of 39 cm, and a size of this type of pants having id2 is relatively small, and “size 26” is only suitable for a user having a waist size of 38 cm. In this way, for a certain business object, when determining models that match with the target body property data of the current first user, a target second correspondence relationship corresponding to the target business objects can be determined first by querying Table 4 as described above, for example. For example, a certain business object is id1, a corresponding second correspondence relationship is as shown in Table 4. When the target body property data is located in a certain target body property data range in the target second correspondence relationship, a model corresponding to the target body property data range can be determined to be the target model. For example, the waist size of the current first user is 39 cm, a target model that matches therewith can be determined to be “size 26”. Similarly, for another business object in the set, for example, id2, a matched model is determined to be “size 27” for the current first user having the waist size of 39 cm.

As can be seen, using the second implementation as described above, although an amount of data that needs to be stored is increased, the accuracy of matching is improved, thus helping the user to determine information of more suitable model and further improving the effectiveness of business object information.

The third database as described above can be created in a number of different ways, for example, in an implementation, extraction and collection can be made from data such as detailed description information of business objects published by second users, comment information of first users, conversations between the first users and customer personnel of the second users. Alternatively, in another implementation, an option of operation used for uploading information of a second correspondence relationship as described above may also be provided to a second user when the second user published business object information. The specific second correspondence relationship that is uploaded by the second user according to the business object can be directly stored by the server. This can improve the data accuracy.

In short, after the target body property data of the current target first user and the target models that match the target body property data for the business objects in the first business object information are determined, respective inventories of corresponding models of the business objects can be determined. In implementations, information about inventories of business objects is generally stored in a server of a designated inventory center. Therefore, a query request can be sent to the server of the inventory center, and inventory information of the corresponding models of the business objects is returned from the server of the inventory center.

At S110, business object information is provided to the client of the target first user based on a determination result.

Specifically, a number of different types of implementations can exist for providing business objects based on a determination result. For example, if a corresponding target model of a certain business object is in stock (e.g., an inventory of “size 26” of a certain jeans matching with the current first user exists), this business object is proved to be valid for the first user. If the first user is interested in this business object, a model problem will not lead to a failure of the first user to make a purchase. Therefore, the business object can be provided to the first user. Moreover, if a corresponding model of a certain business object is out of stock, two situations may exist. One may be that the model of the business object was not produced during manufacture. Another situation is that the target model has been sold out and is no longer provided for sales service. Even if information of this business object is provided to the first user, the first user is not able to purchase a model that satisfies his/her need, and therefore the information of the business object is not provided to the first user. In other words, only business objects having target models being in stock form a second business object set, and display content in a list page is provided to the client using the second business object set. Apparently, in another implementation, former business objects in the first business object set can also be provided to the client of the first user, but business objects with models being out of stock may be labeled. As such, the client can add certain identifiers to these business objects with models being out of stock in the list page, for example, displaying in a form such as text (e.g., “sold out”, “unavailable”, etc.) to prompt to the first user that he/she may not necessarily enter into purchase pages thereof to make a purchase, etc.

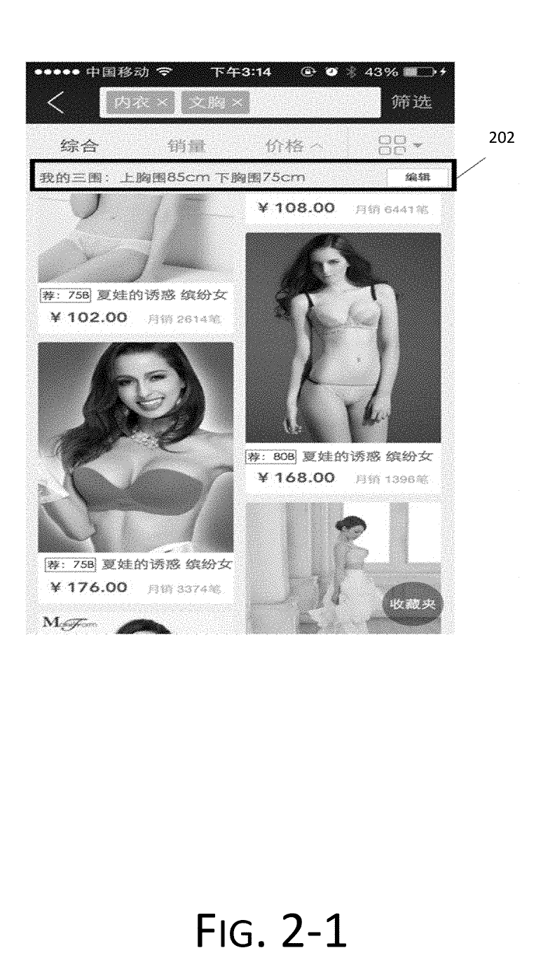

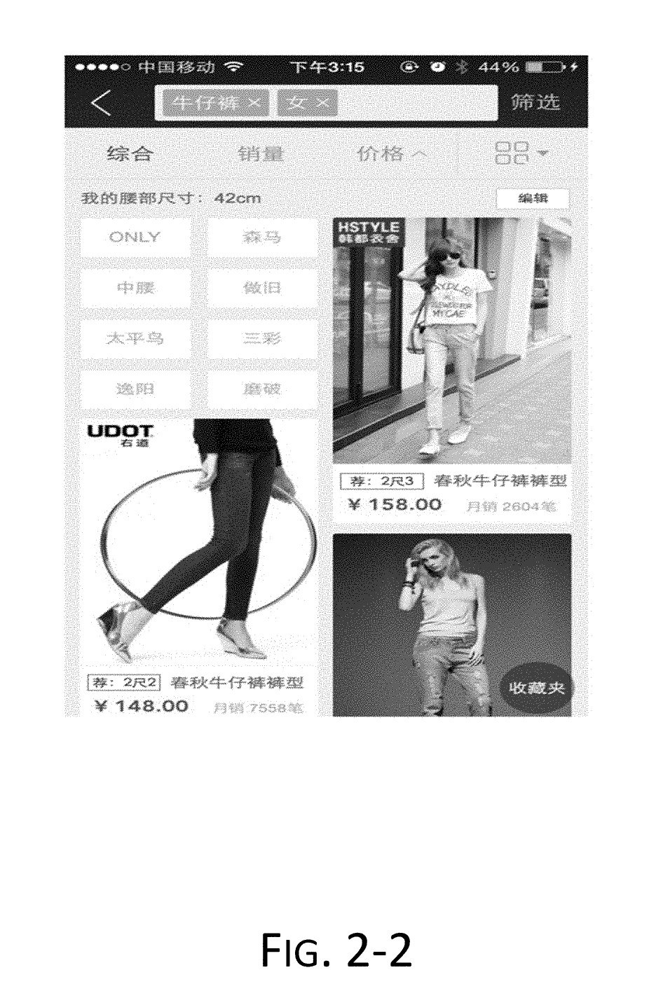

In implementations, when returning the business object information to the client of the first user, the server may also return model information to the client for the business objects with the models being in stock. The client can display this type of model information in the list page directly, to enable the first user to determine models of business objects that are suitable for him/her more intuitively. A number of different ways may exist for providing this type of model information. For example, in an implementation, since information of links of various business objects are generally provided when the server provides display content in the list page to the client of the first user, and the links generally include two parts (images and texts), target model information corresponding to the business objects can be added into respective texts of the links. As such, the client can present this type of target model information in the respective texts of the links. For example, referring to FIG. 2-1, when a first user searches for “bra”, texts of links of various business objects that are returned may include information such as “[recommend: 75B]”, “[recommend: 80B]”, etc. For another example, referring to FIG. 2-2, when a first user searches for “jeans”, texts of links of various business objects that are returned may include information such as “[recommend: 2.3 meter]”, “[recommend: 2.2 meter]”, etc.

Furthermore, in a situation in which all business objects in a business object set belong to a same category, reference dimension(s) of body property data related to this category and body property data value(s) of a current first user in the reference dimension(s) are provided to a client of the first user, to allow the client of the first user to display in a list page. In this case, an option of operation for modifying this body property data may also be provided. For example, label 202 in FIG. 2-1 displays “my measurements: upper chest size 85 cm, lower chest size 75 cm”, and a button with an “edit” label may also be displayed. This button is an option of operation for modifying the body property data. If the current first user notes that the displayed information is incorrect, or the body property data thereof has changed, modification can be made through this option. After modification, the client of the first user can upload the modified body property data to the server. The server updates the business object information that is provided based on the modified body property data. The server may also update the body property data of the first user that is stored in the first database, and then provide business object information using the updated body property data.

Using the embodiments of the present disclosure, body property data of first users can be stored in advance. In this way, when a business object information set is provided to a first user, body property data of the user can first be matched with models of business objects, and a determination is made as to whether a matched model of a business object is in stock. Business object information can thereby be provided based on a determination result. For example, only business object information of matched models that are in stock is provided to a client of the first user. This can reduce the waste of network resources caused by transmission of invalid information. Furthermore, the effectiveness of information displayed in a list interface of a client is improved. This is especially true in a situation where browsing is performed in a small-screen device such as a mobile device. Since a number of business objects that are displayed in each screen are limited, the improvement in the effectiveness of information is more meaningful.

### Second Embodiment

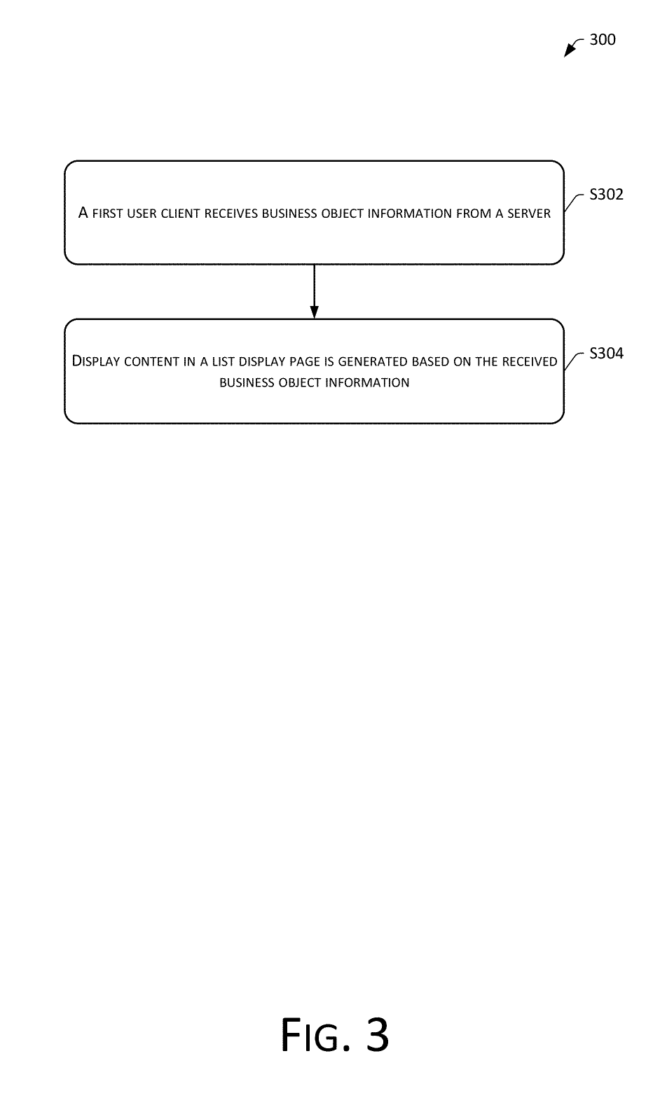

The second embodiment corresponds to the first embodiment, and provides a method 300 for providing business object information from the perspective of a client of a first user. Referring to FIG. 3, the method 300 may include the following operations.

At S302, a first user client receives business object information from a server, the business object information being determined by the server using a way as follows: pre-establishing a first database by the server, the first database being used for storing body property data of first users, determining a first business object information set for a client of a target first user; determining target body property data of the target first user based on the first database, determining whether inventories of target models that match with the target body property data exist in business objects in the first business object information set, and providing business object information to the first user client based on a determination result.

At S304, display content in a list display page is generated based on the received business object information.

In implementations, the information returned by the server further includes the models corresponding to the business objects. In this case, information of the models may also be displayed in the list display page. Specifically, the information of the models can be displayed in texts of a links of the business objects.

Furthermore, the information returned by the server may further include target body property data of the target first user with respect to reference dimension(s) corresponding to a same target category when the business objects in the first business object set belong to the target category. In this case, the client may further display the target body property data of the target first user with respect to the reference dimension(s) that correspond(s) to the target category in the list display page. Furthermore, an option of operation for editing the body property data with respect to the reference dimension(s) in the list page. When modified body property data is received through this option of operation, the modified body property data is uploaded to the server, to enable the server to update provided business object information based on the modified body property data.

The second embodiment corresponds to the first embodiment. Details of related implementations can be referenced to the description of the first embodiment, and are not repeatedly described herein.

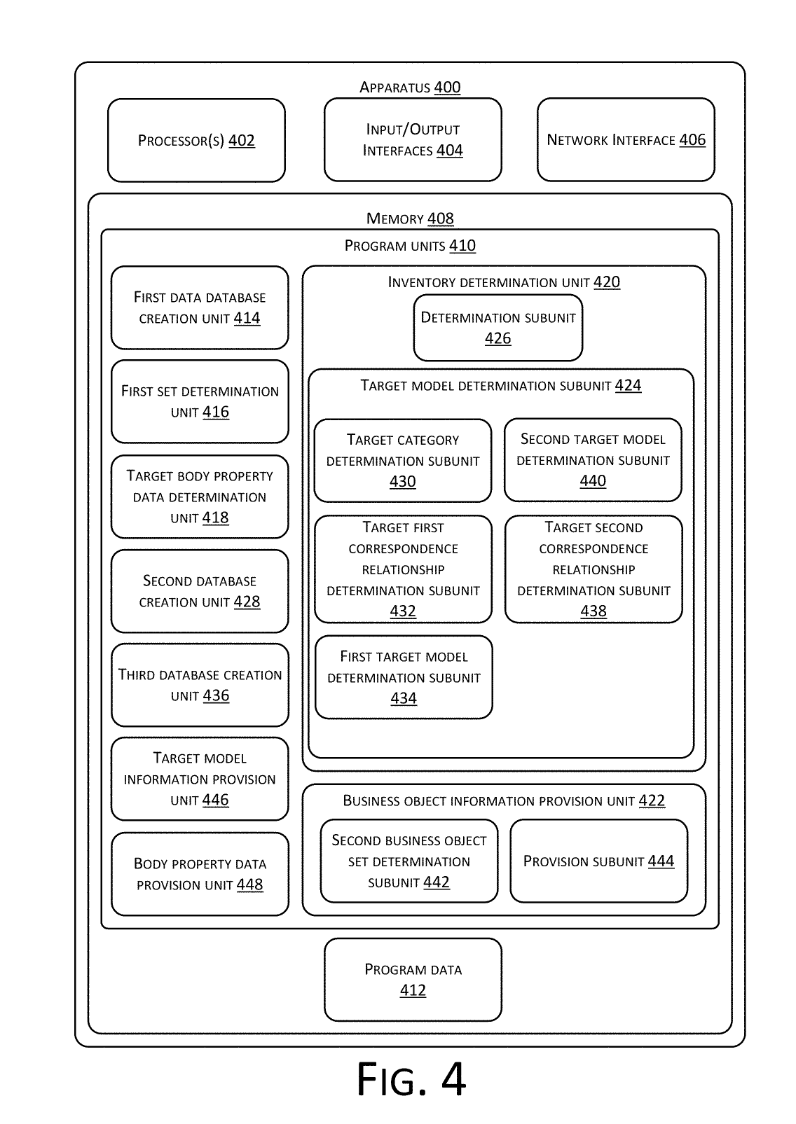

In correspondence with the first embodiment, the embodiments of the present disclosure further provides an apparatus 400 for providing business object information, which is applied in a server. Referring to FIG. 4, the apparatus 400 may include one or more processors 402, an input/output (I/O) interface 404, a network interface 406, and memory 408.

The memory 408 may include a form of computer readable media such as a volatile memory, a random access memory (RAM) and/or a non-volatile memory, for example, a read-only memory (ROM) or a flash RAM. The memory 408 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 408 may include program units 410 and program data 412. The program units 410 may include a first data database creation unit 414 used for pre-establishing a first database by a server, the first database being used for storing body property data of first users; a first set determination unit 416 used for determining a first business object information set for a client of a target first user; a target body property data determination unit 418 used for determining target body property data of the target first user based on the first database; an inventory determination unit 420 used for determining whether an inventory of a target model that matches the target body property data exists in business objects in the first business object information set; and a business object information provision unit 422 used for providing business object information to the client of the target first user based on a determination result.

The target body property data determination unit 418 is used for extracting the target body property data of the target first user in corresponding body property data reference dimensions from the first database based on respective categories to which the business objects in the first business object information set belong and correspondence relationships between the categories and the reference dimensions.

In implementations, the inventory determination unit 420 may include a target model determination subunit 424 used for determining models of the business objects in the first business object information set that match with the body property data of the current first user; and a determination subunit 426 used for determining whether inventories of the models of the business objects exist by accessing a server of an inventory center.

In implementations, the apparatus may further include a second database creation unit 428 used for pre-establishing a second database, the second database being used for storing first correspondence relationships between models of business objects and body property data ranges, wherein each business object category corresponds to a different first correspondence relationship, and dimensions of the body property data are different in different first correspondence relationships.

The target model determination subunit 424 includes a target category determination subunit 430 used for determining target categories to which the business objects belong for the business objects in the first business object information set; a target first correspondence determination subunit 432 used for determining respective first correspondence relationships corresponding to the target categories; and a first target model determination subunit 434 used for setting models corresponding to target body property data ranges to be matched target models when the target property data is located in the target body property data ranges of the target first correspondence relationships.

The first set determination unit 416 is used for determining the first business object information set based on information of a designated category included in a browsing request when receiving the browsing request for browsing the designated category from the client of the target first user.

The target category determination subunit 430 is used for setting the information of the designated category included in the browsing request as the target category to which the business objects belong.

Alternatively, the first set determination unit 416 is used for determining the first business object information set based on a search keyword included in a search request when receiving the search request from the client of the target first user.

The target category determination subunit 430 is used for determining category information corresponding to the search keyword included in the search request and setting the category information as the target category to which the business objects belong.

In another implementation, the apparatus 400 may further include a third database creation unit 436 used for pre-establishing a third database, the third database being used for storing second correspondence relationships between the models of the business objects and the body property data ranges, wherein the business objects individually correspond to the second correspondence relationships thereof.

In this case, the target model determination subunit 424 includes a target second correspondence relationship determination subunit 438 used for determining target second correspondence relationships corresponding to the target business objects for the target business objects in the first business object information set; and a second target model determination subunit 440 used for setting models corresponding to target body property data ranges to be matched target models when the target property data is located in the target body property data ranges of the target second correspondence relationships.

In implementations, the business object information provision unit 422 includes a second business object set determination subunit 442 used for forming a second business object set using business objects with target models being in stock; and a provision subunit 444 used for providing the display content in the list page to the client using the second business object set.

In order to provide more intuitive information, the apparatus 400 may further include a target model information provision 446 unit used for providing information of the target models for the business objects with the target models being in stock, to enable the client of the first user to display the information of the target models of the business objects in the list page.

Specifically, the target model information provision unit 446 is used for adding the information of the target models in texts of respective links of the business objects for the business objects with the target models being in stock.

Furthermore, the apparatus 400 may also include a body property data provision unit 448 used for providing target body property data of the target first user in reference dimensions corresponding to a target category to the client of the first user when the business objects in the first business object set all belong to this same target category, to allow the client of the first user to display thereof in the list page.

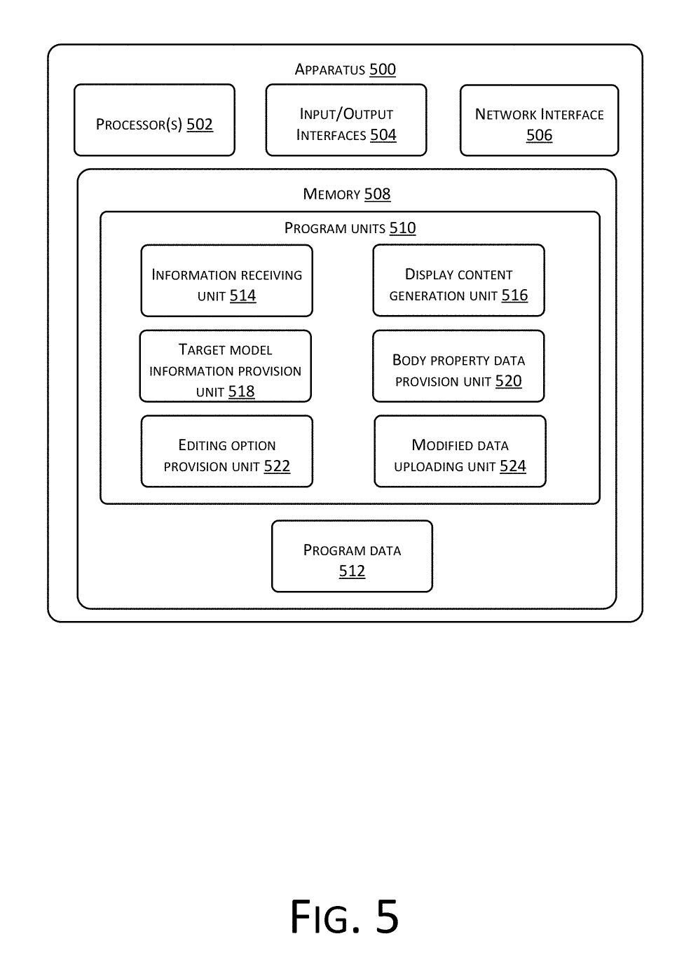

In correspondence with the second embodiment, the embodiments of the present disclosure also provide an apparatus 500 for providing business object information, which is applied in a client of a first user. Referring to FIG. 5, the apparatus 500 may include one or more processors 502, an input/output (I/O) interface 504, a network interface 506, and memory 508. The memory 508 may include a form of computer readable media as described above.

In implementations, the memory 508 may include program units 510 and program data 512. The program units 510 may include an information receiving unit 514 used for receiving business object information from a server by a first user client, the business object information being determined by the server using a way including pre-establishing a first database by the server, the first database being used for storing body property data of first users, determining a first business object information set for a client of a target first user; determining target body property data of the target first user based on the first database, determining whether an inventory of a target model that matches the target body property data exists in business objects in the first business object information set, and providing business object information to the first user client based on a determination result; and a display content generation unit 516 used for generating display content in a list display page based on the received business object information.

The information returned by the server further includes the models corresponding to the business objects. The apparatus 500 further includes a target model information provision unit 518 used for displaying information of the models in the list display page. Specifically, the target model information provision unit is used for displaying the information of the models in texts of links of the business objects.

The information returned by the server may further include target body property data of the target first user with respect to reference dimension(s) corresponding to a same target category when the business objects in the first business object set belong to the target category. The apparatus 500 further includes a body property data provision unit 520 used for displaying the target body property data of the target first user with respect to the reference dimension(s) that correspond(s) to the target category in the list display page. Furthermore, the apparatus 500 may further include an editing option provision unit 522 used for providing an option of operation for editing the body property data with respect to the reference dimension(s) in the list page; and a modified data uploading unit 524 used for uploading modified body property data to the server when the modified body property data is received through this option of operation, to enable the server to update provided business object information based on the modified body property data.

Using the embodiments of the present disclosure, body property data of first users can be stored in advance. In this way, when a business object information set is provided to a first user, body property data of the user can first be matched with models of business objects, and a determination is made as to whether a matched model of a business object is in stock. Business object information can thereby be provided based on a determination result. For example, only business object information of matched models that are in stock is provided to a client of the first user. This can reduce the waste of network resources caused by transmission of invalid information. Furthermore, the effectiveness of information displayed in a list interface of a client is improved. This is especially true in a situation where browsing is performed in a small-screen device such as a mobile device. Since a number of business objects that are displayed in each screen are limited, the improvement in the effectiveness of information is more meaningful.

Through the above description of the embodiments, one skilled in the art can understand that the embodiments of the present disclosure can be implemented in a form of software with a necessary universal hardware platform. Based on such understanding, the essence of technical solutions of the embodiments of the present disclosure or contributions to the existing technologies may be embodied in a form of a software product. The software product may be stored in a non-volatile storage media (such as a CD-ROM, a magnetic disk, an optical drive, etc.), and includes instructions that enable a computing device (may be a personal computer, a server, or a network device) to execute each embodiment or a portion of the method of each embodiment of the present disclosure.

The embodiments of the present disclosure are described in a progressive manner. The same or similar portions of the embodiments can be referenced with each other. Each embodiment places an emphasis differently from other embodiments. Because of being basically similar to the method embodiments, the description of the systems or system embodiments is relatively brief, and can be referenced to related portions of the method embodiments. The foregoing systems and system embodiments are merely exemplary. Units that are described as separate components may or may not be physically separate. A component that is presented as a unit may or may not be a physical unit, i.e., may be located in a single location, or may be distributed among a plurality of network units. Some or all of the modules may be selected to implement the purpose of the solution of the present embodiments based on actual needs. One of ordinary skill in the art can understand and implement the present disclosure without making any creative effort.

Methods and apparatuses for providing business object information are described in detail above. The present disclosure uses examples to describe the principles and embodiments of the present disclosure. The description of the foregoing embodiments is merely used to help understand the methods and concepts of the present disclosure. Based on the concepts of the present disclosure, one of ordinary skill in the art can make changes to the specific embodiments and application scopes. In short, content of the present specification should not be construed as limitations to the present disclosure.

The present disclosure may be further understood with clauses as follows.

Clause 1: A method for providing business object information, comprising: pre-establishing a first database by a server, the first database being used for storing body property data of first users; determining a first business object information set for a client of a target first user; determining target body property data of the target first user based on the first database; determining whether inventories of target models that match the target body property data exists in business objects in the first business object information set; and providing business object information to the client of the target first user based on a determination result.

Clause 2: The method of Clause 1, wherein determining the target body property data of the target first user based on the first database comprises extracting the target body property data of the target first user in corresponding reference dimensions of the body property data from the first database based on categories to which the business objects in the first business object information set belong and a pre-established correspondence relationships between the categories and the reference dimensions.

Clause 3: The method of Clause 1, wherein determining whether the inventories of the target models that match the target body property data exists in the business objects in the first business object information set comprises: determining the target models of the business object in the first business object information set that match the body property data of the first user; and determining whether the target models of the business objects are in stock by accessing a server of an inventory center.

Clause 4: The method of Clause 3, further comprising pre-establishing a second database, wherein the second database is used for storing first correspondence relationships between the models of the business objects and body property data ranges, each business object category corresponds to a different first correspondence relationship, and dimensions of the body property data are different in different first correspondence relationships, wherein determining the target models of the business object in the first business object information set that match the body property data of the first user comprises: determining a target category to which the business object belong for the business objects in the first business object information set; determining a first correspondence relationship corresponding to the target category; and setting models corresponding to a target body property data range as the matched target models when the target body property data is located in the target body property data range in the first correspondence relationship.

Clause 5: The method of Clause 4, wherein: determining the first business object information set for the client of the target first user comprises determining the first business object information set based on information of a designated category included in a browsing request when receiving the browsing request for browsing the designated category from the client of the target first user, and determining the target category to which the business object belong for the business objects in the first business object information set comprises setting the information of the designated category included in the browsing request as the target category to which the business objects belong.

Clause 6: The method of Clause 4, wherein: determining the first business object information set for the client of the target first user comprises determining the first business object information set based on a search keyword included in a search request when receiving the search request from the client of the target first user, and determining category information corresponding to the search keyword included in the search request and setting the category information as the target category to which the business objects belong.

Clause 7: The method of Clause 3, further comprising pre-establishing a third database, the third database being used for storing second correspondence relationships between the models of the business objects and the body property data ranges, wherein the business objects individually correspond to the second correspondence relationships, wherein determining the target models of the business object in the first business object information set that match the body property data of the first user comprises: determining target second correspondence relationships corresponding to the target business objects for the target business objects in the first business object information set; and setting models corresponding to target body property data ranges to be matched target models when the target property data is located in the target body property data ranges of the target second correspondence relationships.

Clause 8: The method of Clause 1, wherein providing the business object information to the client of the target first user based on the determination result comprises: forming a second business object set using business objects with target models being in stock; and providing the display content in a list page to the client using the second business object set.

Clause 9: The method of Clause 1, further comprising providing information of the target models for the business objects with the target models being in stock, to enable the client of the first user to display the information of the target models of the business objects in a list page.

Clause 10: The method of Clause 9, wherein providing the information of the target models for the business objects with the target models being in stock comprises adding the information of the target models in texts of respective links of the business objects for the business objects with the target models being in stock.

Clause 11: The method of Clause 1, further comprising providing target body property data of the target first user in reference dimensions corresponding to a target category to the client of the first user when the business objects in the first business object set all belong to the target category, to allow the client of the first user to display thereof in a list page.

Clause 12: A method for providing business object information, comprising: receiving business object information from a server by a first user client, the business object information being determined by the server using a way including pre-establishing a first database by the server, the first database being used for storing body property data of first users, determining a first business object information set for a client of a target first user; determining target body property data of the target first user based on the first database, determining whether inventories of target models that match the target body property data exists in business objects in the first business object information set, and providing business object information to the first user client based on a determination result; and generating display content in a list display page based on the received business object information.

Clause 13: The method of Clause 12, wherein the information returned by the server further comprises the models corresponding to the business objects, and the method further comprises displaying information of the models in the list display page.

Clause 14: The method of Clause 13, wherein displaying the information of the models in the list display page comprises displaying the information of the models in texts of links of the business objects.

Clause 15: The method of Clause 12, wherein the information returned by the server further comprises target body property data of the target first user with respect to a reference dimension corresponding to a same target category when the business objects in the first business object set belong to the target category, and the method further comprises displaying the target body property data of the target first user in the reference dimension corresponding to the target category in the list display page.

Clause 16: The method of Clause 15, further comprising: providing an option of operation for editing the body property data in the reference dimension in the list page; and uploading modified body property data to the server when the modified body property data is received through the option of operation, to enable the server to update provided business object information based on the modified body property data.

Clause 17: An apparatus for providing business object information, which is applied in a server, the apparatus comprising: a first data database creation unit used for pre-establishing a first database by a server, the first database being used for storing body property data of first users; a first set determination unit used for determining a first business object information set for a client of a target first user; a target body property data determination unit used for determining target body property data of the target first user based on the first database; an inventory determination unit used for determining whether inventories of target models that match the target body property data exists in business objects in the first business object information set; and a business object information provision unit used for providing business object information to the client of the target first user based on a determination result.

Clause 18: The apparatus of Clause 17, wherein the target body property data determination unit is used for extracting the target body property data of the target first user in corresponding reference dimensions of the body property data from the first database based on categories to which the business objects in the first business object information set belong and pre-established correspondence relationships between the categories and the reference dimensions.

Clause 19: The apparatus of Clause 17, wherein the inventory determination unit comprises: a target model determination subunit used for determining the target models of the business object in the first business object information set that match the body property data of the first user; and a determination subunit used for determining whether the target models of the business objects are in stock by accessing a server of an inventory center.

Clause 20: The apparatus of Clause 19, further comprising a second database creation unit used for pre-establishing a second database, wherein the second database is used for storing first correspondence relationships between the models of the business objects and body property data ranges, each business object category corresponds to a different first correspondence relationship, and dimensions of the body property data are different in different first correspondence relationships, wherein the target model determination subunit comprises: a target category determination subunit used for determining a target category to which the business object belong for the business objects in the first business object information set; a target first correspondence relationship determination subunit used for determining a first correspondence relationship corresponding to the target category; and a first target model determination subunit used for setting models corresponding to a target body property data range as the matched target models when the target body property data is located in the target body property data range in the first correspondence relationship.

Clause 21: The apparatus of Clause 20, wherein: the first set determination unit is used for determining the first business object information set based on information of a designated category included in a browsing request when receiving the browsing request for browsing the designated category from the client of the target first user, and the target category determination subunit is used for setting the information of the designated category included in the browsing request as the target category to which the business objects belong.

Clause 22: The apparatus of Clause 20, wherein: the first set determination unit is used for determining the first business object information set based on a search keyword included in a search request when receiving the search request from the client of the target first user, and the target category determination subunit is used for determining category information corresponding to the search keyword included in the search request and setting the category information as the target category to which the business objects belong.

Clause 23: The apparatus of Clause 19, further comprising a third database creation unit used for pre-establishing a third database, the third database being used for storing second correspondence relationships between the models of the business objects and the body property data ranges, wherein the business objects individually correspond to the second correspondence relationships, wherein the target model determination subunit comprises: a target second correspondence relationship determination subunit used for determining target second correspondence relationships corresponding to the target business objects for the target business objects in the first business object information set; and a second target determination subunit used for setting models corresponding to target body property data ranges to be matched target models when the target property data is located in the target body property data ranges of the target second correspondence relationships.

Clause 24: The apparatus of Clause 17, wherein the business object information provision unit comprises: a second business object set determination subunit used for forming a second business object set using business objects with target models being in stock; and a provision subunit used for providing the display content in a list page to the client using the second business object set.

Clause 25: The apparatus of Clause 17, further comprising a target model information provision unit used for providing information of the target models for the business objects with the target models being in stock, to enable the client of the first user to display the information of the target models of the business objects in a list page.

Clause 26: The apparatus of Clause 25, wherein the target model information provision unit is used for adding the information of the target models in texts of respective links of the business objects for the business objects with the target models being in stock.

Clause 27: The apparatus of Clause 17, further comprising a body property data provision unit used for providing target body property data of the target first user in reference dimensions corresponding to a target category to the client of the first user when the business objects in the first business object set all belong to the target category, to allow the client of the first user to display thereof in a list page.

Clause 28: An apparatus for providing business object information, comprising: an information receiving unit used for receiving business object information from a server by a first user client, the business object information being determined by the server using a way including pre-establishing a first database by the server, the first database being used for storing body property data of first users, determining a first business object information set for a client of a target first user; determining target body property data of the target first user based on the first database, determining whether inventories of target models that match the target body property data exists in business objects in the first business object information set, and providing business object information to the first user client based on a determination result; and a display content generation unit used for generating display content in a list display page based on the received business object information.

Clause 29: The apparatus of Clause 28, wherein the information returned by the server further comprises the models corresponding to the business objects, and the apparatus further comprises a target model information provision unit used for displaying information of the models in the list display page.

Clause 30: The apparatus of Clause 28, wherein the target model information provision unit is used for displaying the information of the models in texts of links of the business objects.

Clause 31: The apparatus of Clause 27, wherein the information returned by the server further comprises target body property data of the target first user with respect to a reference dimension corresponding to a same target category when the business objects in the first business object set belong to the target category, and the apparatus further comprises a body property data provision unit used for displaying the target body property data of the target first user in the reference dimension corresponding to the target category in the list display page.

Clause 32: The apparatus of Clause 30, further comprising: an editing option provision unit used for providing an option of operation for editing the body property data in the reference dimension in the list page; and a modified data uploading unit used for uploading modified body property data to the server when the modified body property data is received through the option of operation, to enable the server to update provided business object information based on the modified body property data.

What is claimed is:

1. A method implemented by a server, the method comprising:
pre-establishing a first database, the first database being used for storing body property data of first users;
determining a first business object information set for a client of a target first user;
determining target body property data of the target first user based on the first data base;
determining whether inventories of target models that match the target body property data exists in business objects in the first business object information set; and
providing business object information to the client of the target first user based on a determination result.

2. The method of claim 1, wherein determining the target body property data of the target first user based on the first database comprises extracting the target body property data of the target first user in corresponding reference dimensions of the body property data from the first database based on categories to which the business objects in the first business object information set belong and pre-established correspondence relationships between the categories and the reference dimensions.

3. The method of claim 1, wherein determining whether the inventories of the target models that match the target body property data exists in the business objects in the first business object information set comprises:
determining the target models of the business object in the first business object information set that match the body property data of the first user; and
determining whether the target models of the business objects are in stock by accessing a server of an inventory center.

4. The method of claim 3, further comprising pre-establishing a second database, wherein the second database is used for storing first correspondence relationships between the models of the business objects and body property data ranges, each business object category corresponds to a different first correspondence relationship, and dimensions of the body property data are different in different first correspondence relationships, wherein determining the target models of the business object in the first business object information set that match the body property data of the first user comprises:
determining a target category to which the business object belong for the business objects in the first business object information set;
determining a first correspondence relationship corresponding to the target category; and
setting models corresponding to a target body property data range as the matched target models when the target body property data is located in the target body property data range in the first correspondence relationship.

5. The method of claim 4, wherein:
determining the first business object information set for the client of the target first user comprises determining the first business object information set based on information of a designated category included in a browsing request when receiving the browsing request for browsing the designated category from the client of the target first user, and
determining the target category to which the business object belong for the business objects in the first business object information set comprises setting the information of the designated category included in the browsing request as the target category to which the business objects belong.

6. The method of claim 4, wherein:
determining the first business object information set for the client of the target first user comprises determining the first business object information set based on a search keyword included in a search request when receiving the search request from the client of the target first user, and
determining category information corresponding to the search keyword included in the search request and setting the category information as the target category to which the business objects belong.

7. The method of claim 3, further comprising pre-establishing a third database, the third database being used for storing second correspondence relationships between the models of the business objects and the body property data ranges, wherein the business objects individually correspond to the second correspondence relationships, wherein determining the target models of the business object in the first business object information set that match the body property data of the first user comprises:
determining target second correspondence relationships corresponding to the target business objects for the target business objects in the first business object information set; and
setting models corresponding to target body property data ranges to be matched target models when the target property data is located in the target body property data ranges of the target second correspondence relationships.

8. The method of claim 1, wherein providing the business object information to the client of the target first user based on the determination result comprises:
forming a second business object set using business objects with target models being in stock; and
providing the display content in a list page to the client using the second business object set.

9. The method of claim 1, further comprising providing information of the target models for the business objects with the target models being in stock, to enable the client of the first user to display the information of the target models of the business objects in a list page.

10. The method of claim 9, wherein providing the information of the target models for the business objects with the target models being in stock comprises adding the information of the target models in texts of respective links of the business objects for the business objects with the target models being in stock.

11. The method of Clause 1, further comprising providing target body property data of the target first user in reference dimensions corresponding to a target category to the client of the first user when the business objects in the first business object set all belong to the target category, to allow the client of the first user to display thereof in a list page.

12. One or more computer-readable media storing executable instructions that, when executed by one or more processors, cause the one or more processors to perform acts comprising:
receiving business object information from a server by a first user client, the business object information being determined by the server using a way including pre-establishing a first database by the server, the first database being used for storing body property data of first users, determining a first business object information set for a client of a target first user; determining target body property data of the target first user based on the first database, determining whether inventories of target models that match the target body property data exists in business objects in the first business object information set, and providing business object information to the first user client based on a determination result; and
generating display content in a list display page based on the received business object information.

13. The one or more computer-readable media of claim 12, wherein the information returned by the server further comprises the models corresponding to the business objects, and the method further comprises displaying information of the models in the list display page.

14. The one or more computer-readable media of claim 13, wherein displaying the information of the models in the list display page comprises displaying the information of the models in texts of links of the business objects.

15. The one or more computer-readable media of claim 12, wherein the information returned by the server further comprises target body property data of the target first user with respect to a reference dimension corresponding to a same target category when the business objects in the first business object set belong to the target category, and the acts further comprise displaying the target body property data of the target first user in the reference dimension corresponding to the target category in the list display page.

16. The one or more computer-readable media of claim 15, the acts further comprising:
providing an option of operation for editing the body property data in the reference dimension in the list page; and
uploading modified body property data to the server when the modified body property data is received through the option of operation, to enable the server to update provided business object information based on the modified body property data.

17. An apparatus for providing business object information, which is applied in a server, the apparatus comprising:
a first data database creation unit used for pre-establishing a first database by a server, the first database being used for storing body property data of first users;
a first set determination unit used for determining a first business object information set for a client of a target first user;
a target body property data determination unit used for determining target body property data of the target first user based on the first database;
an inventory determination unit used for determining whether inventories of target models that match the target body property data exists in business objects in the first business object information set; and
a business object information provision unit used for providing business object information to the client of the target first user based on a determination result.

18. The apparatus of claim 17, wherein the target body property data determination unit is used for extracting the target body property data of the target first user in corresponding reference dimensions of the body property data from the first database based on categories to which the business objects in the first business object information set belong and pre-established correspondence relationships between the categories and the reference dimensions.

19. The apparatus of claim 17, wherein the inventory determination unit comprises:
a target model determination subunit used for determining the target models of the business object in the first business object information set that match the body property data of the first user; and
a determination subunit used for determining whether the target models of the business objects are in stock by accessing a server of an inventory center.

20. The apparatus of claim 19, further comprising a second database creation unit used for pre-establishing a second database, wherein the second database is used for storing first correspondence relationships between the models of the business objects and body property data ranges, each business object category corresponds to a different first correspondence relationship, and dimensions of the body property data are different in different first correspondence relationships, wherein the target model determination subunit comprises:
a target category determination subunit used for determining a target category to which the business object belong for the business objects in the first business object information set;
a target first correspondence relationship determination subunit used for determining a first correspondence relationship corresponding to the target category; and
a first target model determination subunit used for setting models corresponding to a target body property data range as the matched target models when the target body property data is located in the target body property data range in the first correspondence relationship.
